(19) United States
(12) Patent Application Publication
(10) Pub. No.: US 2012/0179627 A1
(43) Pub. Date: Jul. 12, 2012

(54) UPSIDE INVESTING METHOD AND SYSTEM

(75) Inventors: Laurence Kotlikoff, Lexington, MA (US); Richard Munroe, Belmont, MA (US)

(73) Assignee: ECONOMIC SECURITY PLANNING, INC., Lexington, MA (US)

(21) Appl. No.: 13/342,356

(22) Filed: Jan. 3, 2012

Related U.S. Application Data
(60) Provisional application No. 61/430,369, filed on Jan. 6, 2011.

(51) Int. Cl. G06Q 40/06

(52) U.S. Cl. 705/36 R

(57) ABSTRACT

An economic security, saving, spending, and investing financial planning method and system are disclosed, to calculate the smoothest possible living standard floor for a household, which does not necessitate borrowing or spending out of risky investments; and to show the extent to which the household's living standard floor may rise once risky investments are converted to safe investments.

### REFERENCE TO RELATED PATENT AND APPLICATION

This application relates to, and claims priority to, U.S. Provisional Patent Application Ser. No. 61/430,369, filed Jan. 6, 2011. This application is also related to U.S. Pat. No. 6,611,807, issued Aug. 26, 2003, which is hereby incorporated by reference.

### FIELD OF THE INVENTION

This invention relates to the field of financial planning.

### BACKGROUND

Traditional financial planning seeks to limit the probability that households will suffer a decline in their living standard via two primary means—investing a higher share of assets in safe securities, such as US Treasury Inflation Protected Securities, and investing the remaining, risky assets in a diversified manner. Laddering of bonds is an example of the former strategy, and buying a market-weighted equity index funded is an example of the latter strategy.

Neither of these strategies is effective in fully insulating households from downside living standard risk for the simple reason that traditional financial planning does not directly determine what the household can spend each year to maintain its living standard. Instead, traditional planning asks households to set post-retirement spending targets on their own. In so doing, households are likely to consider all their assets, risky and safe, in specifying how much they will spend. If, in retirement, they adhere to these targets they will be led to spend on the presumption that risky assets will deliver an assumed return in the future, which may prove incorrect. In this case, the household will have spent more early in life than had it been clairvoyant about the future returns on its risky investments and, by necessity, be forced to reduce its spending or risk an even greater spending decline later on. Consequently, households setting spending targets in light of their current and project future risky assets are at risk of experiencing a decline in their living standards.

Traditional financial planning can also lead to downside living standard risk even when all assets are invested safely. The reason is that households are typically asked either to set their own spending targets or to use a crude rule of thumb to determine their targets. These rules of thumb are of two types. One—the replacement rate targeting method—seeks to set post-retirement spending as a share, typically 75 percent to 85 percent, of pre-retirement income. The other sets post-retirement spending at a fraction, typically 4 percent, of the total value of assets brought into retirement. Neither methodology provides any guidance for adjusting the spending target if, in fact, the target is wrong.

Another shortcoming of traditional financial planning with respect to securing a floor to a household's living standard is that the planning is focused on spending only after retirement. If the spending target is set too high, this will require a reduction in spending before retirement. If the spending target is set too low, the household will be led to save too little and spend too much prior to retirement and, consequently, experience a drop in its living standard in retirement.

U.S. Pat. No. 6,611,807, issued Aug. 26, 2003, incorporated herein by reference, determines a sustainable living standard for households who are investing exclusively in safe assets. The iterative dual dynamic programming methodology described and claimed in U.S. Pat. No. 6,611,807, solves the basic problem, which is highly complex given the multifaceted and interconnected tax, social security, pension, inflation, insurance, demographic, housing, real estate, retirement account, and liquidity issues.

### SUMMARY

A method for determining a smooth-over-time living standard floor for an entity is disclosed, which does not necessitate borrowing or spending out of risky assets. The method comprises the steps of:
A. Identifying a set of asset holdings associated with the entity, where the asset holdings include safe assets and risky assets; and
B. determining a function representative of a smooth consumption of the safe assets over time for the entity.

The entity, in some cases, is a household. In other cases, the entity is an individual, or household, or other legal entity. Preferably, the determining step is performed at least in part on a digital computer. Again, preferably, the function-determining step includes an iterative dual dynamic programming step, for example, as disclosed in the incorporated reference, U.S. Pat. No. 6,611,807.

In a form, the safe assets and risky assets include present assets owned by the entity and future assets include assets anticipated-to-be-owned by the entity.

A system for determining a smooth over time living standard floor for an entity is disclosed, which does not necessitate borrowing or spending out of risky assets. The system includes a digital computer. In a form, the digital computer is:
A. adapted to store data representative of a set of asset holdings associated with the entity, where the asset holdings include safe assets and risky assets; and
B. adapted to determine a function representative of a smooth consumption of the asset holdings over time for the entity.

The entity, in some cases, is a household. In other cases, the entity is an individual, or household, or other legal entity.

Preferably, the digital computer is adapted to determine the function using an iterative dual dynamic programming method. In a form, the safe assets and risky assets include present assets owned by the entity and future assets anticipated-to-be-owned by the entity.

### BRIEF DESCRIPTION OF THE DRAWINGS

A more complete appreciation of the present invention, and many of the attendant advantages thereof, will be better understood by reference to the following detailed description when considered in connection with the accompanying drawings, wherein:

FIG. 1 is a flow diagram illustrating an upside investing method; and

FIG. 2 is a block diagram illustrating an upside investing system.

### DESCRIPTION

The present method and system provides an improvement over the method and system of U.S. Pat. No. 6,611,807, referred to hereinbelow as the “Iterative Dual Dynamic Programming”, or “IDDP”, method and system, respectively. The IDDP method and IDDP system provide a financial strategy that establishes a floor to an entity's (such as a household's) living standard when it also invests in risky assets. The present method and system distinguishes between “risky assets” and “safe assets”, and treats investing in “risky assets” in a similar manner as many households treat gambling in a casino. Many, if not most casino patrons enter the casino with a fixed amount of money they are prepared to lose. In so doing, they are setting a floor to their living standard. In addition, such casino patrons determine not to spend their winnings, if they are indeed positive, until they have stopped gambling and left the casino. The present method and system generally treats “safe assets” in a manner similar to the IDDP treatment of assets in the incorporated reference, U.S. Pat. No. 6,611,807.

The terms “safe assets” and “risky assets” are relative terms, and each individual, or entity, using the disclosed method would define each of his, her or its various assets to be in one or the other of those categories. While the disclosed system and method relate particularly to exemplary systems and methods utilizing two categories of assets, more sophisticated systems and methods define multiple categories for the assets, “safe” and “risky”, having finer granularity, all in keeping with the disclosed exemplary method and exemplary system. Increased granularity requires more complex computational and tracking effort, but generally provides better results.

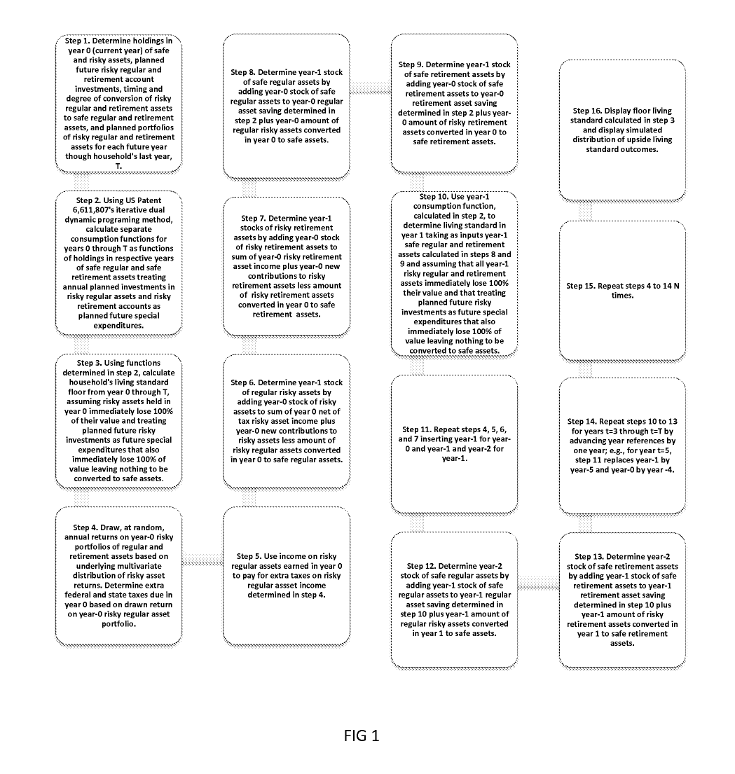

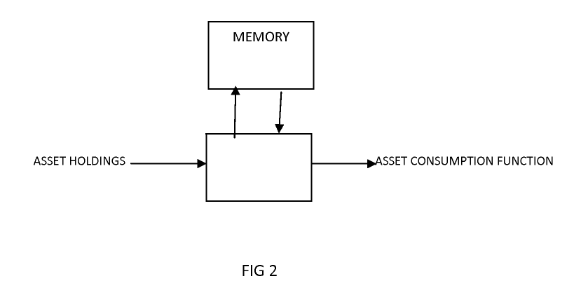

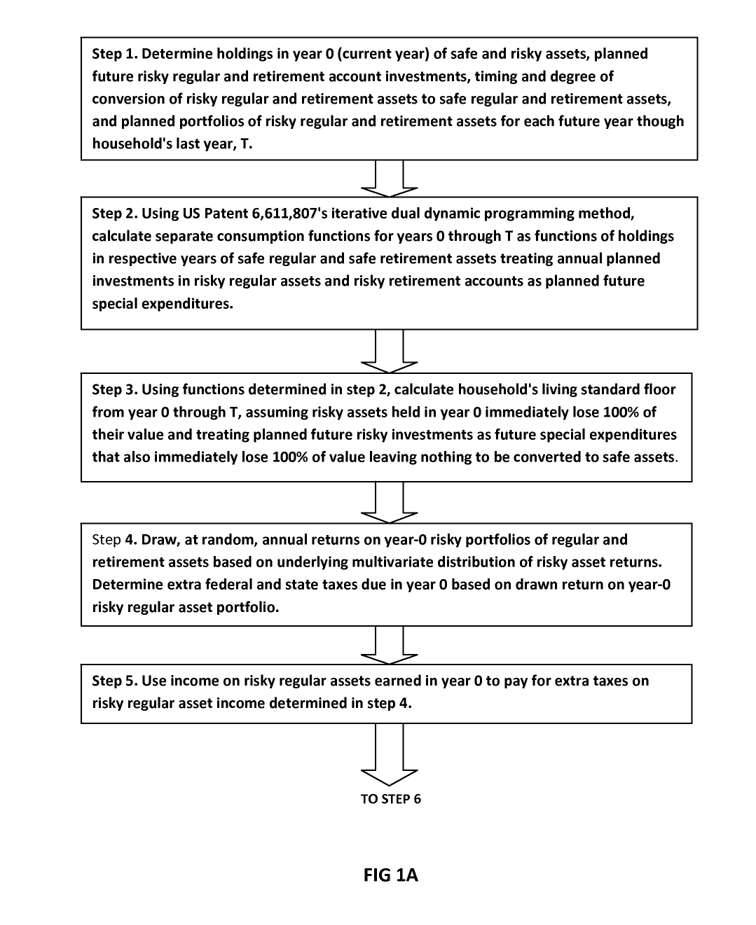

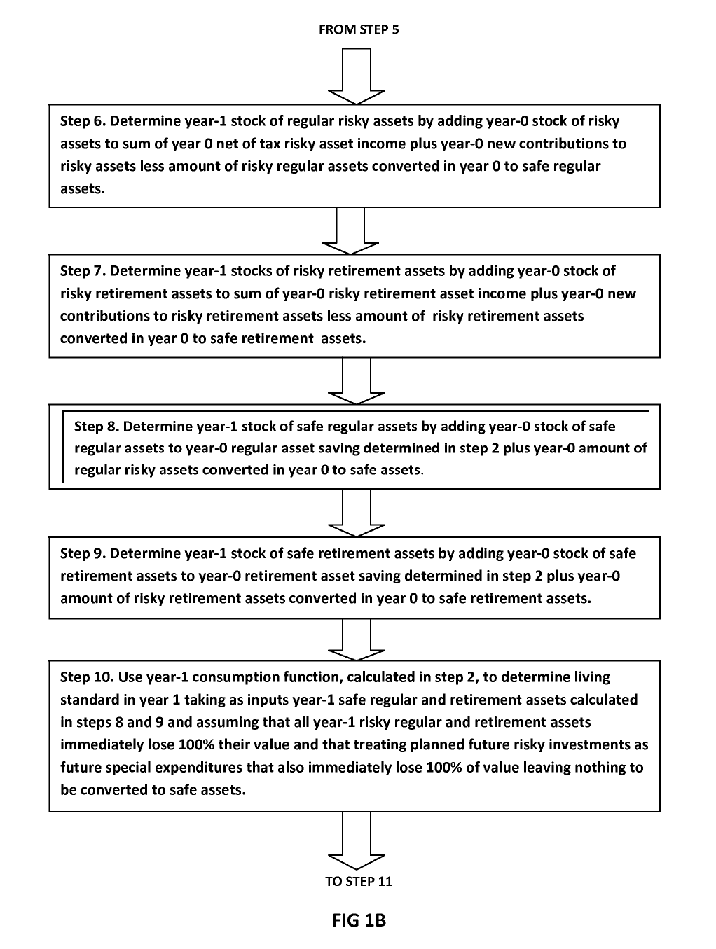

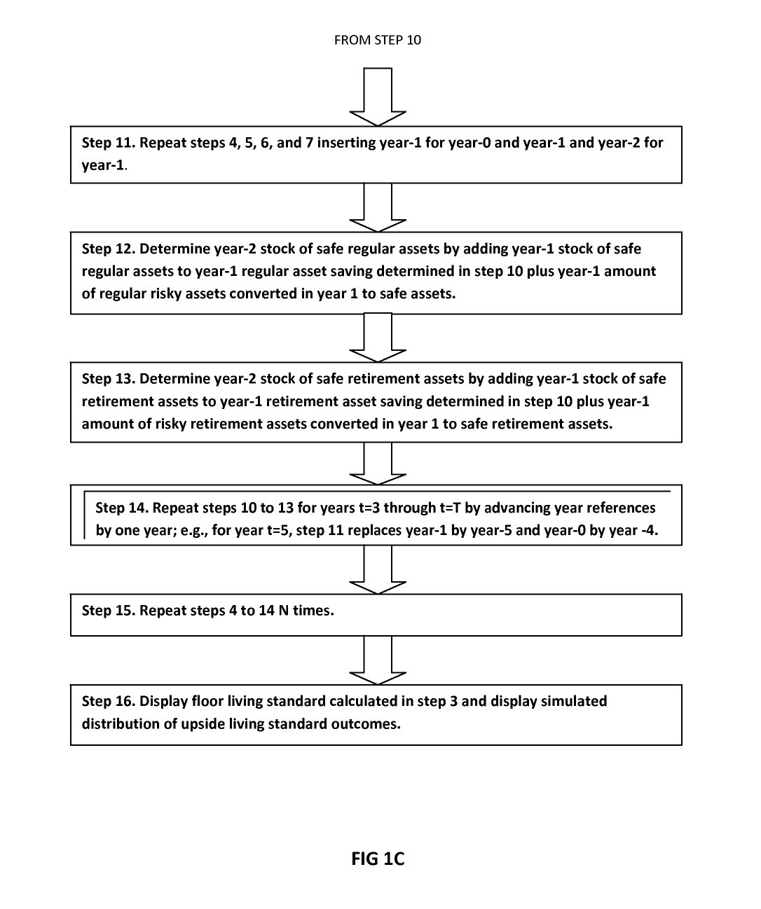

An exemplary method and an exemplary system are shown in FIG. 1 and FIG. 2, respectively. The system includes a digital computer and an associated memory. The computer receives information representative of asset holdings for an entity, and produces information representative of an asset consumption function, whereby the entity is provided with a formulation for a smooth consumption of the its safe assets over time, The entity can engage in a smooth-over-time living standard floor, which does not necessitate borrowing or spending out of risky assets.

A form of the method utilizes the following steps:

Step 1. Determine holdings in year 0 (current year) of safe assets and risky assets, planned future risky regular and retirement account investments, timing and degree of conversion of risky regular and retirement assets to safe regular and retirement assets, and planned portfolios of risky regular and retirement assets for each future year though household's last year.

Step 2. Using U.S. Pat. No. 6,611,807's iterative dual dynamic programming (IDDP) method, calculate separate consumption functions for years 0 through T as functions of holdings in respective years of safe regular and safe retirement assets treating annual planned investments in risky regular assets and risky retirement accounts as planned future special expenditures.

Step 3. Using functions determined in step 2, calculate household's living standard floor from year 0 through T, assuming risky assets held in year 0 immediately lose 100% of their value and treating planned future risky investments as future special expenditures that also immediately lose 100% of value leaving nothing to be converted to safe assets.

Step 4. Draw, at random, annual returns on year-0 risky portfolios of regular and retirement assets based on underlying multivariate distribution of risky asset returns. Determine extra federal and state taxes due in year 0 based on drawn return on year-0 risky regular asset portfolio.

Step 5. Use income on risky regular assets earned in year 0 to pay for extra taxes on risky regular asset income determined in step 4.

Step 6. Determine year-1 stock of regular risky assets by adding year-0 stock of risky assets to sum of year 0 net of tax risky asset income plus year-0 new contributions to risky assets less an amount of risky regular assets converted in year 0 to safe regular assets.

Step 7. Determine year-1 stocks of risky retirement assets by adding year-0 stock of risky retirement assets to sum of year-0 risky retirement asset income plus year-0 new contributions to risky retirement assets less amount of risky retirement assets converted in year 0 to safe retirement assets.

Step 8. Determine year-1 stock of safe regular assets by adding year-0 stock of safe regular assets to year-0 regular asset saving determined in step 2 plus year-0 amount of regular risky assets converted in year 0 to safe assets.

Step 9. Determine year-1 stock of safe retirement assets by adding year-0 stock of safe retirement assets to year-0 retirement asset saving determined in step 2 plus year-0 amount of risky retirement assets converted in year 0 to safe retirement assets.

Step 10. Use year-1 consumption function, calculated in step 2, to determine living standard in year 1 taking as inputs year-1 safe regular and retirement assets calculated in steps 8 and 9 and assuming that all year-1 risky regular and retirement assets immediately lose 100% their value and that treating planned future risky investments as future special expenditures that also immediately lose 100% of value leaving nothing to be converted to safe assets.

Step 11. Repeat steps 4, 5, 6, and 7 inserting year-1 for year-0 and year-1 and year-2 for year-1.

Step 12. Determine year-2 stock of safe regular assets by adding year-1 stock of safe regular assets to year-1 regular asset saving determined in step 10 plus year-1 amount of regular risky assets converted in year 1 to safe assets.

Step 13. Determine year-2 stock of safe retirement assets by adding year-1 stock of safe retirement assets to year-1 retirement asset saving determined in step 10 plus year-1 amount of risky retirement assets converted in year 1 to safe retirement assets.

Step 14. Repeat steps 10 to 13 for years t=3 through t=T by advancing year references by one year; e.g., for year t=5, step 11 replaces year-1 by year-5 and year-0 by year-4.

Step 15. Repeat steps 4 to 14 N times.

Step 16. Display floor living standard calculated in step 3 and display simulated distribution of upside living standard outcomes.

Following step 16, the memory stores data representative of floor living standard calculated in step 3 and the simulated distribution of upside living standard outcomes.

Pursuant to the method and system, entities such as households specify how much they currently have in risky assets, how much and when they will be adding to their risky assets in terms of additional contributions to, for example, a brokerage account, when they will begin converting their risky assets to safe assets and when they will complete this conversion.

A floor is established to the household's living standard by using the IDDP method of U.S. Pat. No. 6,611,807 to calculate the household's sustainable living standard, assuming that: a) its initial risky asset holdings, both in retirement accounts and in non-retirement accounts (referenced as regular assets), are lost entirely before they are converted to safe assets; and b) additional contributions to holdings of risky regular assets and risky retirement assets are likewise entirely lost prior to the household's specified period of conversion.

Monte Carlo simulations confirm that the potential for higher spending and, thus, higher living standards, if the household succeeds in accumulating positive amounts of risky assets in years when it is converting risky to safe assets. If this occurs, the household raises its spending because the conversion has delivered to it higher levels of safe assets.

The method, as exemplified for a household in FIG. 1, entails: a) taking random draws of returns on the risky regular and risky retirement account assets; and b) accumulating the stocks of these assets taking into account contributions to these holdings, taxes that must be paid on the risky regular asset income, and withdrawals for conversion purposes once such conversions commence. In accordance with the present method, money invested in risky assets is not spent until it has been safely transformed into safe assets. Consequently, the household cannot experience a lower living standard than its floor, which is a monotonically increasing function of time. The household can only experience different increases in its living standard floor once conversion of risky to safe assets commences.

In calculating the upside from any past sequence of returns on risky asset holdings, the present method uses, in each year, the IDDP method of U.S. Pat. No. 6,611,807 to determine the amount that can safely be spent given the safe asset holdings (including those just converted), while assuming that no subsequent conversions will take place (i.e., by assuming that all remaining risky assets will be lost entirely).

In summary, in accordance with the present method, the household spends at any point in time, only out of safe assets that it accumulated in the past or recently converted from its risky holdings. Households do not spend out of risky assets, which have not yet been converted to safe assets, no matter the magnitude of such risky assets.

In accordance with the method, households determine the tradeoff between their floor and their upside from investing more in risky assets. The greater the degree of risky investment, the lower will be the household's living standard floor and the greater will be its upside. Conversely, the smaller the extent of risky investing, the higher will be the household's living standard floor, but the lower will be its upside.

As described herein, the digital computer can include hardware, firmware, and/or software (executing in hardware). For example, some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although the present method has been described in terms of certain embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

1. A method for determining a smooth-over-time living standard floor for an entity, which does not necessitate borrowing or spending out of risky assets, comprising the steps of:
A. Identifying a set of asset holdings associated with the entity, the asset holdings including safe assets and risky assets; and
B. Determining a function representative of a smooth consumption of the safe assets over time for the entity.

2. The method of claim 1 wherein the entity is a household.

3. The method of claim 1 wherein the determining step is performed at least in part on a digital computer.

4. The method of claim 1 wherein the safe assets and risky assets include present assets owned by the entity and future assets anticipated-to-be-owned by the entity.

5. The method of claim 1 wherein the function-determining step includes an iterative dual dynamic programming step.

6. A system for determining a smooth-over-time living standard floor for an entity, which does not necessitate borrowing or spending out of risky assets, comprising:
a digital computer
A. adapted to store data representative of a set of asset holdings associated with the entity, the asset holdings including safe assets and risky assets; and
B. adapted to determine a function representative of a smooth consumption of the asset holdings over time for the entity.

7. The system of claim 6 wherein the entity is a household.

8. The system of claim 6 wherein the digital computer is adapted to determine the function using an iterative dual dynamic programming method.

9. The system of claim 6 wherein the safe assets and risky assets include present assets owned by the entity and future assets anticipated-to-be-owned by the entity.
